(19) United States
(12) Patent Application Publication
(10) Pub. No.: US 2025/0110507 A1
(43) Pub. Date: Apr. 3, 2025

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Sango Matsuzaki, Wako-shi (JP); Misa Komuro, Wako-shi (JP)

(21) Appl. No.: 18/897,302

(22) Filed: Sep. 26, 2024

(30) Foreign Application Priority Data
Sep. 29, 2023 (JP) 2023-169688

(51) Int. Cl. G05D 1/646; G05D 1/686; G05D 111/10

(52) U.S. Cl. CPC G05D 1/646; G05D 1/686; G05D 2111/10

(57) ABSTRACT

A mobile object control device includes a storage medium which stores computer-readable instructions, and a processor which is connected to the storage medium, the processor executes the computer-readable instructions to: recognize a surrounding situation of a mobile object on the basis of at least a captured image of a surrounding situation of the mobile object, generate a route from the mobile object to a destination on the basis of the recognized surrounding situation and the set destination, judge whether or not an angle formed by a proceeding direction of the mobile object along the generated route and a straight line from the mobile object to the destination satisfies a predetermined condition, and control the mobile object such that the mobile object moves to the destination along the generated route. When it is judged that the angle satisfies the predetermined condition, the processor causes the mobile object to turn instantly and regenerates a route from the mobile object which has turned instantly to the destination.

### CROSS-REFERENCE TO RELATED APPLICATION

Priority is claimed on Japanese Patent Application No. 2023-169688, filed Sep. 29, 2023, the content of which is incorporated herein by reference.

### BACKGROUND

### Field of the Invention

The present invention relates to a mobile object control device, a mobile object control method, and a storage medium.

### Description of Related Art

In the related art, robots that guide a user to a desired place and transport luggage are known (for example, refer to Japanese Unexamined Patent Application, First Publication No. 2012-111011). The foregoing robots refer to a movement speed database in which a maximum movement speed is associated with each of areas within the environment and move at a movement speed with the set maximum movement speed as the upper limit.

However, when the robot according to the technology in the related art generates a route toward a destination, there are cases in which an inefficient route is generated without changing the orientation of the robot.

### SUMMARY

The present invention has been made in consideration of such circumstances, and an object thereof is to provide a mobile object control device, a mobile object control method, and a storage medium, in which generation of an inefficient route regarding an orientation of a robot can be curbed when a route toward a destination is generated.

A mobile object control device, a mobile object control method, and a storage medium according to this invention employ the following constitutions.

(1): A mobile object control device according to an aspect of this invention includes a storage medium which stores computer-readable instructions, and a processor which is connected to the storage medium. The processor executes the computer-readable instructions to: recognize a surrounding situation of a mobile object on the basis of at least a captured image of a surrounding situation of the mobile object, generate a route from the mobile object to a destination on the basis of the recognized surrounding situation and the set destination, judge whether or not an angle formed by a proceeding direction of the mobile object along the generated route and a straight line from the mobile object to the destination satisfies a predetermined condition, and control the mobile object such that the mobile object moves to the destination along the generated route. When it is judged that the angle satisfies the predetermined condition, the processor causes the mobile object to turn instantly and regenerates a route from the mobile object which has turned instantly to the destination.

(2): According to the aspect of the foregoing (1), the predetermined condition is that the angle is equal to or larger than a first threshold.

(3): According to the aspect of the foregoing (2), the processor judges whether or not an angle formed by the proceeding direction of the mobile object along the regenerated route and the straight line from the mobile object to the destination is smaller than a second threshold. When it is judged that the angle is smaller than the second threshold, the processor controls the mobile object such that the mobile object moves to the destination along the regenerated route. The second threshold is a value smaller than the first threshold.

(4): According to the aspect of the foregoing (1), the mobile object operates in any mode of a following mode of moving in a manner of following a user, and a guidance mode of moving ahead of the user in accordance with a movement speed of the user.

(5): According to the aspect of the foregoing (4), when the mobile object operates in the following mode, the destination is the user or a location within a predetermined range from the user.

(6): According to the aspect of the foregoing (4), when the mobile object operates in the guidance mode, the destination is a location set by the user or a location within a predetermined range ahead of the user.

(7): According to the aspect of the foregoing (4), when the mobile object operates in the guidance mode, the destination is a provisional location provisionally set so as to reach a final location set by the user.

(8): A mobile object control method according to another aspect of this invention causes a computer to recognize a surrounding situation of a mobile object on the basis of at least a captured image of a surrounding situation of the mobile object, generate a route from the mobile object to a destination on the basis of the recognized surrounding situation and the set destination, judge whether or not an angle formed by a proceeding direction of the mobile object along the generated route and a straight line from the mobile object to the destination satisfies a predetermined condition, and control the mobile object such that the mobile object moves to the destination along the generated route. When it is judged that the angle satisfies the predetermined condition, the mobile object is caused to turn instantly and a route from the mobile object which has turned instantly to the destination is regenerated.

(9): A computer-readable non-transitory storage medium according to another aspect of this invention stores a program causing a computer to recognize a surrounding situation of a mobile object on the basis of at least a captured image of a surrounding situation of the mobile object, generate a route from the mobile object to a destination on the basis of the recognized surrounding situation and the set destination, judge whether or not an angle formed by a proceeding direction of the mobile object along the generated route and a straight line from the mobile object to the destination satisfies a predetermined condition, and control the mobile object such that the mobile object moves to the destination along the generated route. When it is judged that the angle satisfies the predetermined condition, the mobile object is caused to turn instantly and a route from the mobile object which has turned instantly to the destination is regenerated.

According to the aspects of (1) to (9), it is possible to curb generation of an inefficient route regarding an orientation of a robot when a route toward a destination is generated.

### BRIEF DESCRIPTION OF THE DRAWINGS

FIG. 1 is a view showing an example of a constitution of a mobile object system including a mobile object.

FIG. 2 is an explanatory view of an example of a form of utilizing the mobile object.

FIG. 3 is an explanatory view of a guidance mode.

FIG. 4 is a perspective view showing the mobile object.

FIG. 5 is a view showing an example of functional constituents of the mobile object.

FIG. 6 is a view showing an example of a scene in which a route is regenerated when the mobile object travels in a following mode.

FIG. 7 is a view showing an example of a regenerated route when the mobile object travels in the following mode.

FIG. 8 is a view showing an example of a scene in which a route is regenerated when the mobile object travels in the guidance mode.

FIG. 9 is a view showing an example of a regenerated route when the mobile object travels in the guidance mode.

FIG. 10 is a flowchart showing an example of a flow of processing executed by a control device.

### DESCRIPTION OF EMBODIMENT

Hereinafter, with reference to the drawings, an embodiment of a mobile object control device, a mobile object control method, and a storage medium according to the present invention will be described.

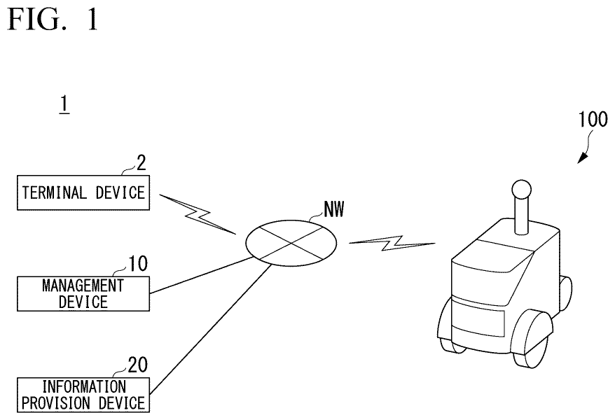

FIG. 1 is a view showing an example of a constitution of a mobile object system 1 including a mobile object 100. For example, the mobile object system 1 includes one or more terminal devices 2, a management device 10, an information provision device 20, and one or more mobile objects 100. For example, these perform communication via a network NW. For example, the network NW is an arbitrary network such as a LAN, a WAN, or an Internet line.

### [Terminal Device]

For example, the terminal device 2 is a computer device such as a smartphone or a tablet terminal. For example, the terminal device 2 requests provision of authority to utilize the mobile object 100 from the management device 10 on the basis of an operation of a user or acquires information indicating that utilization has been permitted.

### [Management Device]

The management device 10 grants authority to utilize the mobile object 100 to a user of the terminal device 2 in accordance with a request from the terminal device 2 or manages a reservation of utilization of the mobile object 100. For example, the management device 10 generates and manages schedule information in which identification information of a user registered in advance is associated with date and time of a reservation of utilization of the mobile object 100.

### [Information Provision Device]

The information provision device 20 provides the position where the mobile object 100 is present, the region where the mobile object 100 moves, and map information of the surroundings of the region to the mobile object 100. The information provision device 20 may generate a route to a destination for the mobile object 100 in accordance with a request of the mobile object 100 and provide the generated route to the mobile object 100.

### [Mobile Object]

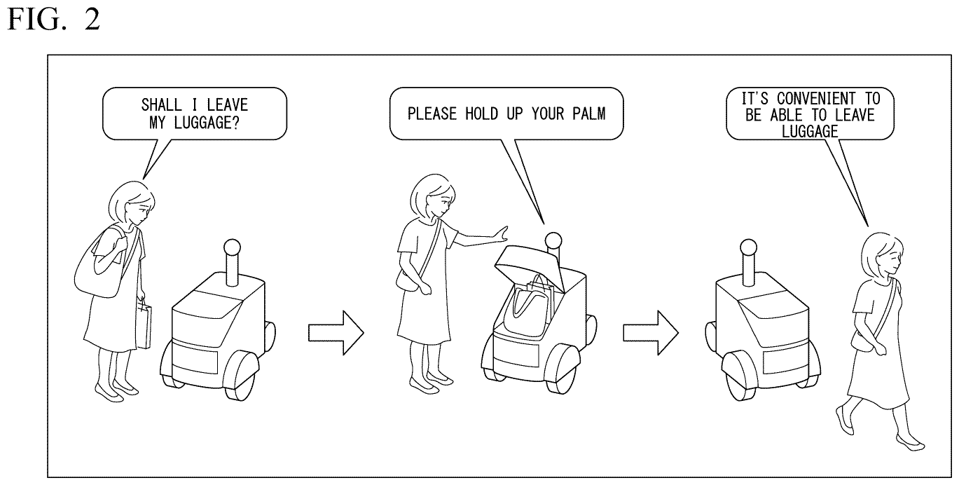

The mobile object 100 is utilized by a user in a utilization form as follows. FIG. 2 is an explanatory view of an example of a form of utilizing the mobile object 100. For example, the mobile object 100 is disposed at a predetermined position in a facility or a street. When it is desired to utilize the mobile object 100, a user can start utilization by operating an operator (not shown) of the mobile object 100 or can start utilization of the mobile object 100 by operating the terminal device 2. For example, when a user goes shopping and has a lot of luggage, the user starts utilizing the mobile object 100 and puts the luggage into a storage of the mobile object 100. Further, the mobile object 100 moves together with the user so as to autonomously follow the user. The user can continue shopping in a state in which luggage is stored in the mobile object 100 or can head to a next destination. For example, the mobile object 100 moves while moving along a sidewalk or a crosswalk on a roadway together with a user. The mobile object 100 can move in regions such as roadways and sidewalks where pedestrians can pass. For example, the mobile object 100 may be utilized within indoor and outdoor facilities and private properties such as shopping centers, airports, parks, and amusement parks and can move in regions where pedestrians can pass.

In addition to (or instead of) a following mode of following a user as described above, the mobile object 100 may be able to autonomously move in other modes such as a guidance mode and an emergency mode.

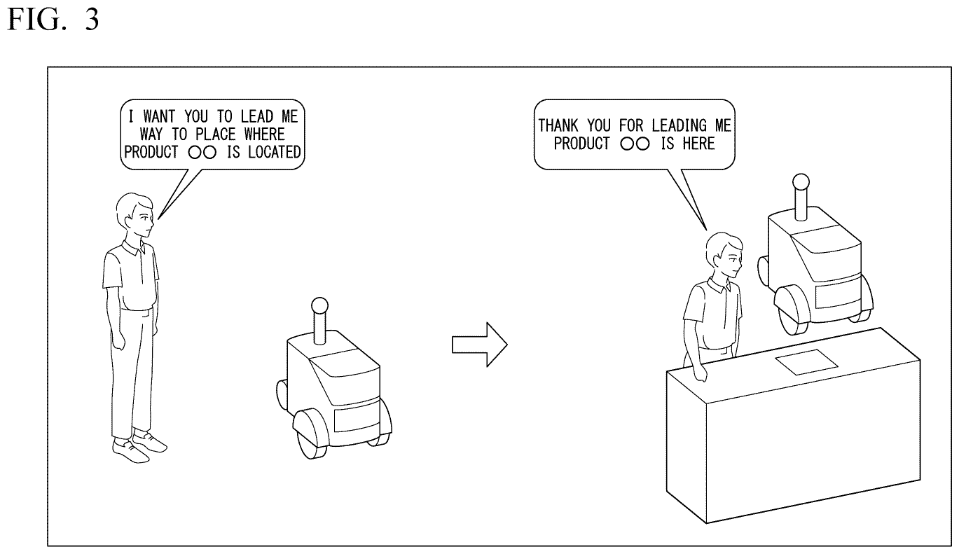

FIG. 3 is an explanatory view of the guidance mode. The guidance mode is a mode of guiding a user to a destination designated by the user and is a mode of guiding a user by autonomously moving ahead of the user in accordance with the movement speed of the user. As shown in FIG. 3, when a user is looking for a predetermined product in a shopping center, if the user requests the mobile object 100 to guide him/her to the location of the predetermined product, the mobile object 100 guides the user to the location of the product. Accordingly, the user can easily find a predetermined product. When the mobile object 100 is utilized in a shopping center, the mobile object 100 or the information provision device 20 retains information in which locations of products, locations of stores, locations of facilities inside the shopping center, and the like are associated with map information, and map information of the shopping center. This map information includes detailed map information including widths of roads and passages, and the like.

The emergency mode is a mode of autonomously moving to ask nearby people or nearby facilities for rescue in order to help a user when something unusual happens to the user (for example, when the user falls down) while moving together with the user. In addition, the mobile object 100 may move while maintaining a distance that is not too close nor not too far from the user, in addition to (or instead of) following and guiding as described above.

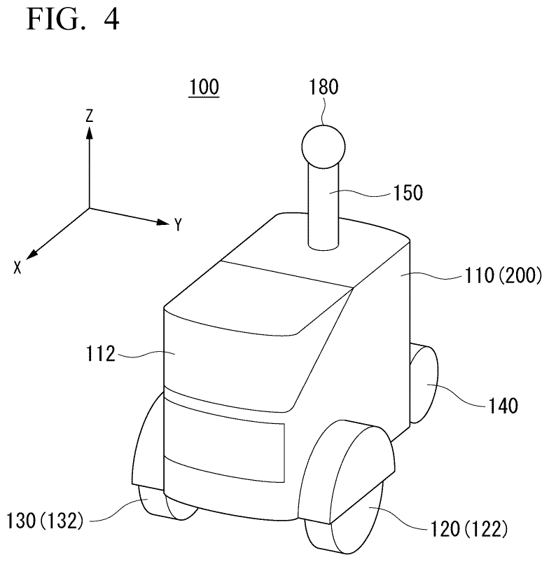

FIG. 4 is a perspective view showing the mobile object 100. In the following description, description will be given while a forward direction of the mobile object 100 is regarded as a positive x direction, a rearward direction of the mobile object 100 is regarded as a negative x direction, a direction toward the left in a width direction of the mobile object 100 with respect to the positive x direction is regarded as a positive y direction, a direction toward the right in the width direction thereof is regarded as a negative y direction, and a direction orthogonal to the x direction and the y direction, that is, a height direction of the mobile object 100 is regarded as a positive z direction.

For example, the mobile object 100 includes a base body 110, a door 112 provided in the base body 110, and wheels (a first wheel 120, a second wheel 130, and a third wheel 140) assembled to the base body 110. For example, a user can put luggage into the storage provided in the base body 110 or can take out luggage from the storage by opening the door 112. The first wheel 120 and the second wheel 130 are driving wheels, and the third wheel 140 is an auxiliary wheel (driven wheel). The mobile object 100 may be able to move using a constitution other than wheels, such as an endless track.

A columnar support body 150 extending in the positive z direction is provided on a surface of the base body 110 in the positive z direction. A camera 180 capturing images of the surroundings of the mobile object 100 is provided in an end portion of the support body 150 in the positive z direction. The position where the camera 180 is provided may be an arbitrary position different from that above.

For example, the camera 180 is a camera capable of capturing images of the surroundings of the mobile object 100 at a wide angle (for example, 360 degrees). The camera 180 may include a plurality of cameras. For example, the camera 180 may be realized by combining a plurality of 120-degree cameras or a plurality of 60-degree cameras.

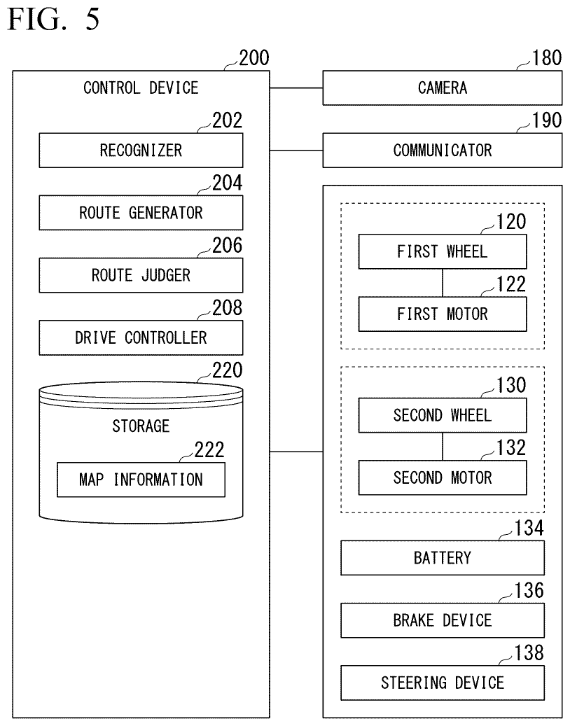

FIG. 5 is a view showing an example of functional constituents of the mobile object 100. In addition to the functional constituents shown in FIG. 4, the mobile object 100 further includes a first motor 122, a second motor 132, a battery 134, a brake device 136, a steering device 138, a communicator 190, and a control device 200. The first motor 122 and the second motor 132 operate by means of power supplied from the battery 134. The first motor 122 drives the first wheel 120, and the second motor 132 drives the second wheel 130. The first motor 122 may be an in-wheel motor provided in the first wheel 120, and the second motor 132 may be an in-wheel motor provided in the second wheel 130.

The brake device 136 outputs a brake torque to each of the wheels on the basis of an instruction of the control device 200. The steering device 138 includes an electric motor. For example, the electric motor changes the direction of the first wheel 120 or the second wheel 130 by causing a force to act on a rack-and-pinion mechanism on the basis of an instruction of the control device 200, thereby changing the course of the mobile object 100.

The communicator 190 is a communication interface for communication with the terminal device 2, the management device 10, or the information provision device 20.

### [Control Device]

For example, the control device 200 includes a recognizer 202, a route generator 204, a route judger 206, a drive controller 208, and a storage 220. For example, the recognizer 202, the route generator 204, the route judger 206, and the drive controller 208 are realized by a hardware processor such as a central processing unit (CPU) executing a program (software). Some or all of these constituent elements may be realized by hardware (circuit; including circuitry) such as a large scale integration (LSI), an application specific integrated circuit (ASIC), a field-programmable gate array (FPGA), or a graphics processing unit (GPU), or may be realized by software and hardware in cooperation. A program may be stored in a storage device such as a hard disk drive (HDD) or a flash memory (a storage device including a non-transitory storage medium) in advance or may be stored in an attachable/detachable storage medium such as a DVD or a CD-ROM (non-transitory storage medium) such that the program is installed when the storage medium is mounted in a drive device. The storage 220 is realized by a storage device such as an HDD, a flash memory, or a random access memory (RAM). The storage 220 stores map information 222 to which the mobile object 100 refers. For example, the map information 222 is map information provided by the information provision device 20, such as the position where the mobile object 100 is present, the region where the mobile object 100 moves, the surroundings of the region, and the like. Some or all of the functional constituents included in the control device 200 may be included in other devices. For example, the mobile object 100 may be controlled in cooperation through communication between other devices and the mobile object 100.

For example, the recognizer 202 recognizes the state of an object around the mobile object 100, such as the position (the distance from the mobile object 100 and the direction with respect to the mobile object 100), the speed, the acceleration, and the like on the basis of images captured by the camera 180. An object includes a traffic participant, an obstacle present inside a facility or on a road, and the like. The recognizer 202 recognizes and tracks a user of the mobile object 100. For example, the recognizer 202 tracks a user on the basis of an image captured by the user (for example, an image of the user's face) registered when the user utilizes the mobile object 100, or an image of the user's face (or a feature amount obtained from an image of the user's face) provided by the terminal device 2 or the management device 10. The recognizer 202 recognizes gestures performed by a user. The mobile object 100 may be provided with a detector such as a radar device or a LIDAR different from the camera. In this case, the recognizer 202 recognizes the situation of the surroundings of the mobile object 100 using detection results of the radar device or the LIDAR, instead of (or in addition to) an image.

The route generator 204 generates a route to a destination on the basis of the situation of the surroundings of the mobile object 100 recognized by the recognizer 202. Here, a destination indicates a user himself/herself that is a following target or a location within a predetermined range from the user when the mobile object 100 is in the following mode. For example, the route generator 204 may set a predetermined location obliquely behind a user as a destination such that the mobile object 100 can be visually recognized from the user while it follows the user. In addition, for example, in order to prevent the mobile object 100 from being too far away from a user, the route generator 204 may determine a destination so as to maintain it within a predetermined distance on the basis of the walking speed of the user. In the case of being in the guidance mode, for example, a destination indicates the location of a product or a facility set by a user. In this case, the user designates the location of a product or a facility, and the mobile object 100 thereby collates the designated location of a product or a facility with the map information 222 and sets, as a destination, the location of a product or a facility identified as a result of collation. In addition, in the case of being in the guidance mode, when the location set by a user is away from the current location of the mobile object 100, the route generator 204 may set the location set by the user as a final destination and set a location within a predetermined range from the current location as a provisional destination. In addition, in the guidance mode, a user does not necessarily have to set a destination, and the mobile object 100 may predict a movement direction of the user and autonomously move ahead of the user in accordance with the movement speed of the user. At this time, the route generator 204 may set a destination for the mobile object 100 as a location within a predetermined range ahead of the user.

A route is a route along which the mobile object 100 can reasonably reach a destination in consideration of the forward direction of the mobile object 100 (that is, the x direction of the mobile object 100). For example, the distance to a destination, the time it takes to reach a destination, the ease of passing a route, and the like are scored, and a route in which the scores and the integrated score of the scores are equal to or larger than a threshold is derived. A route may be generated using an arbitrary algorithm taking at least the forward direction of the mobile object 100 into account. Details of processing executed by the route judger 206 will be described below.

The drive controller 208 controls the motors (the first motor 122 and the second motor 132), the brake device 136, and the steering device 138 such that the mobile object 100 travels along the route generated by the route generator 204.

### [Regeneration of Route]

If a route is generated by the route generator 204, the route judger 206 judges whether or not an angle formed by the proceeding direction of the mobile object 100 along the generated route and a straight line from the mobile object 100 to the destination is equal to or larger than a first threshold Th1. When the route judger 206 judges that the angle is equal to or larger than the first threshold Th1, the drive controller 208 controls the motors (the first motor 122 and the second motor 132) and the steering device 138 such that the mobile object 100 turns instantly. Thereafter, the route generator 204 regenerates a route from the mobile object 100 which has turned instantly to the destination, and the route judger 206 judges whether or not an angle formed by the proceeding direction of the mobile object 100 along the regenerated route and a straight line from the mobile object 100 to the destination is smaller than a second threshold Th2. When the route judger 206 judges that the angle is smaller than the second threshold Th2, the drive controller 208 causes the mobile object 100 to travel along the route regenerated by the route generator 204. Here, the second threshold Th2 is set in advance as a value smaller than the first threshold Th1. By setting the second threshold Th2 as a value smaller than the first threshold Th1 in advance, it is assumed that the regenerated route is a more efficient route regarding the forward direction of the mobile object 100. That is, accordingly, when a route toward a destination is generated, it is possible to curb generation of an inefficient route regarding an orientation of a robot. Hereinafter, a specific example of regeneration of a route according to the mode of the mobile object 100 will be described.

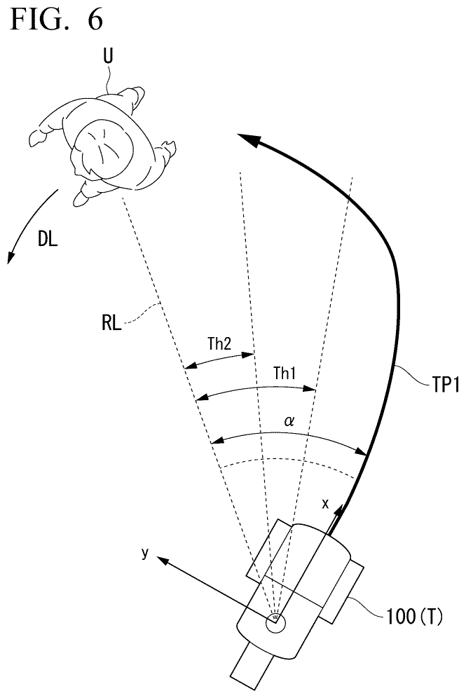

FIG. 6 is a view showing an example of a scene in which a route is regenerated when the mobile object 100 travels in the following mode. In the scene shown in FIG. 6, since the mobile object 100 is traveling in the following mode, a user U himself/herself is set as the destination for the mobile object 100. Moreover, in FIG. 6, the sign DL indicates the proceeding direction of the user U recognized by the recognizer 202. When the mobile object 100 travels in the following mode, the user U may suddenly change a proceeding direction DL. In such a case, the route generator 204 may generate an inefficient route (taking a large detour) for the mobile object 100 in order to follow the user U who has suddenly changed the proceeding direction DL. If a route TP1 is generated by the route generator 204, the route judger 206 judges whether or not an angle α formed by the proceeding direction of the mobile object 100 along the generated route TP1 and a straight line RL from the mobile object 100 to the user U is equal to or larger than the first threshold Th1. In the case of FIG. 6, since the route judger 206 judges that the angle α is equal to or larger than the first threshold Th1, the drive controller 208 causes the mobile object 100 to turn instantly and the route generator 204 regenerates a route from the mobile object 100 which has turned instantly to the user U.

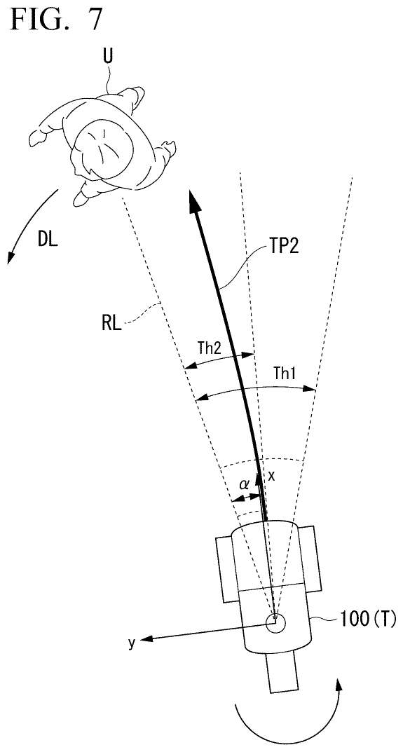

FIG. 7 is a view showing an example of a regenerated route when the mobile object 100 travels in the following mode. The scene shown in FIG. 7 shows a situation in which the drive controller 208 causes the mobile object 100 to turn instantly and the route generator 204 regenerates a route from the mobile object 100 which has turned instantly to the user U in the scene shown in FIG. 6. The route judger 206 judges whether or not the angle α formed by the proceeding direction of the mobile object 100 along a regenerated route TP2 and a straight line from the mobile object 100 to the user U is smaller than the second threshold Th2. In the case of FIG. 7, since the route judger 206 judges that the angle α is smaller than the second threshold Th2, the drive controller 208 causes the mobile object 100 to travel along the route regenerated by the route generator 204. In this manner, the route TP1 generated in the scene shown in FIG. 6 is an inefficient route (taking a large detour) for the mobile object 100 due to sudden change of the proceeding direction DL by the user U. On the other hand, it is assumed that the route TP2 regenerated after the mobile object 100 has been caused to turn instantly will become a more efficient route for the mobile object 100. Accordingly, when the mobile object 100 travels in the following mode, the mobile object 100 can more efficiently follow the user U.

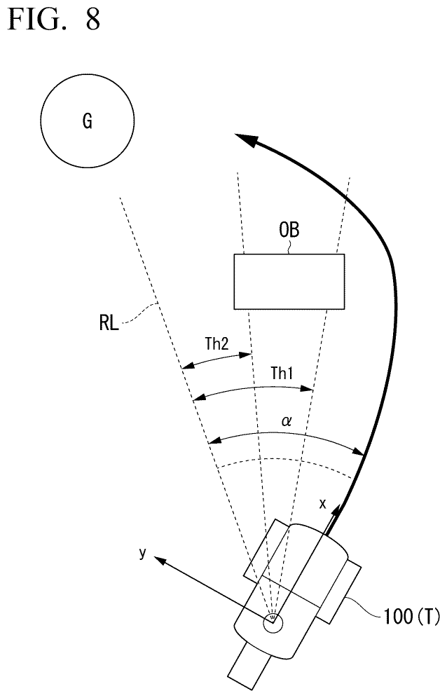

FIG. 8 is a view showing an example of a scene in which a route is regenerated when the mobile object 100 travels in the guidance mode. In the scene shown in FIG. 8, since the mobile object 100 is traveling in the guidance mode, a destination G is set in advance by the user. As an example, FIG. 8 shows a case in which the destination G is the final destination set by the user. However, as described above, the destination G may be a provisional destination within a predetermined range from the current location set so as to reach the final destination set by the user. Moreover, in FIG. 8, the sign OB indicates an obstacle recognized by the recognizer 202. The recognizer 202 may not be able to recognize the obstacle OB until the mobile object 100 approaches the obstacle OB. In such a case, in order to avoid the obstacle OB which has been suddenly recognized, the route generator 204 may generate an inefficient route (taking a large detour) for the mobile object 100. If the route TP1 is generated by the route generator 204, the route judger 206 judges whether or not the angle α formed by the proceeding direction of the mobile object 100 along the generated route TP1 and the straight line RL from the mobile object 100 to the destination G is equal to or larger than the first threshold Th1. In the case of FIG. 8, since the route judger 206 judges that the angle α is equal to or larger than the first threshold Th1, the drive controller 208 causes the mobile object 100 to turn instantly and the route generator 204 regenerates a route from the mobile object 100 which has turned instantly to the destination G.

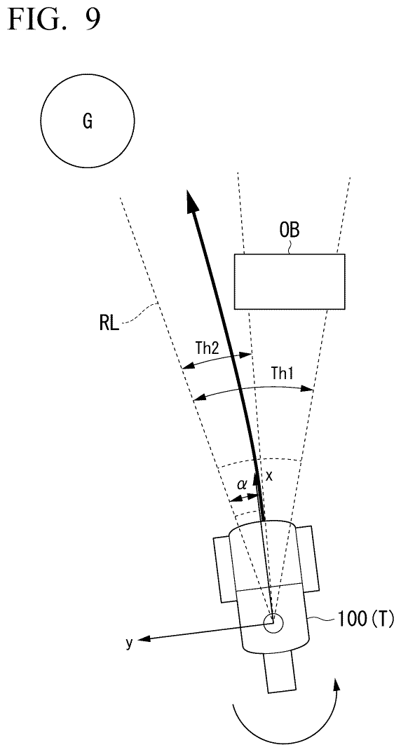

FIG. 9 is a view showing an example of a regenerated route when the mobile object 100 travels in the guidance mode. The scene shown in FIG. 9 shows a situation in which the drive controller 208 causes the mobile object 100 to turn instantly and the route generator 204 regenerates a route from the mobile object 100 which has turned instantly to the destination G in the scene shown in FIG. 8. The route judger 206 judges whether or not the angle α formed by the proceeding direction of the mobile object 100 along the regenerated route TP2 and a straight line from the mobile object 100 to the destination G is smaller than the second threshold Th2. In the case of FIG. 8, since the route judger 206 judges that the angle α is smaller than the second threshold Th2, the drive controller 208 causes the mobile object 100 to travel along the route regenerated by the route generator 204. In this manner, the route TP1 generated in the scene shown in FIG. 6 is an inefficient route (taking a large detour) for the mobile object 100 due to the obstacle OB which has been suddenly recognized. On the other hand, it is assumed that the route TP2 regenerated after the mobile object 100 has been caused to turn instantly will become a more efficient route for the mobile object 100. Accordingly, when the mobile object 100 travels in the guidance mode, the mobile object 100 can more efficiently move to the destination G.

### [Flow of Processing]

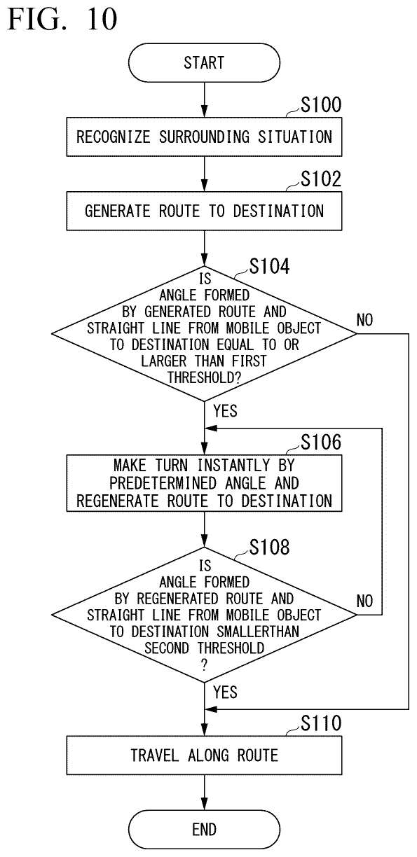

Hereinafter, with reference to FIG. 10, a flow of processing executed by the control device 200 will be described. FIG. 10 is a flowchart showing an example of a flow of processing executed by the control device 200. The processing shown in FIG. 10 is repeatedly executed while the mobile object 100 is traveling in the following mode or the guidance mode.

First, the recognizer 202 recognizes a surrounding situation of the mobile object 100 on the basis of at least a capture image of the surrounding situation of the mobile object 100 (Step S100). Next, the route generator 204 generates a route from the mobile object 100 to the destination on the basis of the recognized surrounding situation and the set destination (Step S102).

Next, the route judger 206 judges whether or not an angle formed by the proceeding direction of the mobile object 100 along the generated route and a straight line from the mobile object 100 to the destination is equal to or larger than the first threshold (Step S104). When it is judged that the angle formed by the proceeding direction of the mobile object 100 along the generated route and the straight line from the mobile object 100 to the destination is smaller than the first threshold, the drive controller 208 causes the mobile object 100 to travel along the route generated by the route generator 204 (Step S110).

When it is judged that the angle formed by the proceeding direction of the mobile object 100 along the generated route and the straight line from the mobile object 100 to the destination is equal to or larger than the first threshold, the drive controller 208 causes the mobile object 100 to turn instantly by a predetermined angle, and the route generator 204 regenerates a route to the destination (Step S106). Next, the route judger 206 judges whether or not an angle formed by the proceeding direction of the mobile object 100 along the regenerated route and a straight line from the mobile object 100 to the destination is smaller than the second threshold (Step S108).

When it is judged that the angle formed by the proceeding direction of the mobile object 100 along the regenerated route and the straight line from the mobile object 100 to the destination is not smaller than the second threshold, the control device 200 executes the processing of Step 106 again. On the other hand, when it is judged that the angle formed by the proceeding direction of the mobile object 100 along the regenerated route and the straight line from the mobile object 100 to the destination is smaller than the second threshold, the drive controller 208 causes the mobile object 100 to travel along the route regenerated by the route generator 204 (Step S110). Accordingly, the processing or this flowchart ends.

According to the present embodiment described as above, when an angle formed by the proceeding direction of the mobile object along the generated route and a straight line from the mobile object to the destination is smaller than the first threshold, the mobile object is caused to travel along the generated route. On the other hand, when it is equal to or larger than the first threshold, a route is regenerated until the angle formed by the proceeding direction of the mobile object along the regenerated route and the straight line from the mobile object to the destination becomes smaller than the second threshold. Accordingly, when a route toward a destination is generated, it is possible to curb generation of an inefficient route regarding an orientation of a robot.

The embodiment described above can be expressed as follows.

A mobile object control device includes a storage medium which stores computer-readable instructions, and a processor which is connected to the storage medium. The processor executes the computer-readable instructions to: recognize a surrounding situation of a mobile object on the basis of at least a captured image of a surrounding situation of the mobile object, generate a route from the mobile object to a destination on the basis of the recognized surrounding situation and the set destination, judge whether or not an angle formed by a proceeding direction of the mobile object along the generated route and a straight line from the mobile object to the destination satisfies a predetermined condition, and control the mobile object such that the mobile object moves to the destination along the generated route. When it is judged that the angle satisfies the predetermined condition, the mobile object is caused to turn instantly and a route from the mobile object which has turned instantly to the destination is regenerated.

Hereinabove, forms for performing the present invention have been described using an embodiment. However, the present invention is not limited to such an embodiment in any way, and various modifications and replacements can be added thereto within a range not departing from the gist of the present invention.

What is claimed is:

1. A mobile object control device comprising:
a storage medium which stores computer-readable instructions; and
a processor which is connected to the storage medium,
wherein the processor executes the computer-readable instructions to:
recognize a surrounding situation of a mobile object on the basis of at least a captured image of a surrounding situation of the mobile object;
generate a route from the mobile object to a destination on the basis of the recognized surrounding situation and the set destination;
judge whether or not an angle formed by a proceeding direction of the mobile object along the generated route and a straight line from the mobile object to the destination satisfies a predetermined condition; and
control the mobile object such that the mobile object moves to the destination along the generated route,
wherein when it is judged that the angle satisfies the predetermined condition, the processor causes the mobile object to turn instantly and regenerates a route from the mobile object which has turned instantly to the destination.

2. The mobile object control device according to claim 1,
wherein the predetermined condition is that the angle is equal to or larger than a first threshold.

3. The mobile object control device according to claim 2,
wherein the processor judges whether or not an angle formed by the proceeding direction of the mobile object along the regenerated route and the straight line from the mobile object to the destination is smaller than a second threshold,
when it is judged that the angle is smaller than the second threshold, the processor controls the mobile object such that the mobile object moves to the destination along the regenerated route, and
the second threshold is a value smaller than the first threshold.

4. The mobile object control device according to claim 1,
wherein the mobile object operates in any mode of a following mode of moving in a manner of following a user, and a guidance mode of moving ahead of the user in accordance with a movement speed of the user.

5. The mobile object control device according to claim 4,
wherein when the mobile object operates in the following mode, the destination is the user or a location within a predetermined range from the user.

6. The mobile object control device according to claim 4,
wherein when the mobile object operates in the guidance mode, the destination is a location set by the user or a location within a predetermined range ahead of the user.

7. The mobile object control device according to claim 4,
wherein when the mobile object operates in the guidance mode, the destination is a provisional location provisionally set so as to reach a final location set by the user.

8. A mobile object control method in which a computer
recognizes a surrounding situation of a mobile object on the basis of at least a captured image of a surrounding situation of the mobile object,
generates a route from the mobile object to a destination on the basis of the recognized surrounding situation and the set destination,
judges whether or not an angle formed by a proceeding direction of the mobile object along the generated route and a straight line from the mobile object to the destination satisfies a predetermined condition, and
controls the mobile object such that the mobile object moves to the destination along the generated route,
wherein when it is judged that the angle satisfies the predetermined condition, the mobile object is caused to turn instantly and a route from the mobile object which has turned instantly to the destination is regenerated.

9. A computer-readable non-transitory storage medium which stores a program causing a computer
to recognize a surrounding situation of a mobile object on the basis of at least a captured image of a surrounding situation of the mobile object,
to generate a route from the mobile object to a destination on the basis of the recognized surrounding situation and the set destination,
to judge whether or not an angle formed by a proceeding direction of the mobile object along the generated route and a straight line from the mobile object to the destination satisfies a predetermined condition, and
to control the mobile object such that the mobile object moves to the destination along the generated route,
wherein when it is judged that the angle satisfies the predetermined condition, the mobile object is caused to turn instantly and a route from the mobile object which has turned instantly to the destination is regenerated.
